(19) United States
(12) Patent Application Publication
(10) Pub. No.: US 2010/0242366 A1
(43) Pub. Date: Sep. 30, 2010

(54) Sliding Pivotable Door

(75) Inventors: Arne Liebscher, Herdecke (DE); Michael Glanz, Koln (DE); Andreas Finke, Gevelsberg (DE); Thomas Wildförster, Schwelm (DE)

Correspondence Address: COHEN, PONTANI, LIEBERMAN & PAVANE LLP, 551 FIFTH AVENUE, SUITE 1210, NEW YORK, NY, 10176, US

(73) Assignee: Dorma GmbH + Cp. KG, Ennepetal (DE)

(21) Appl. No.: 12/750,269

(22) Filed: Mar. 30, 2010

(30) Foreign Application Priority Data
Mar. 30, 2009 (DE) 10 2009 014 869.8

(51) Int. Cl. E05F 15/18; E06B 3/50; E05D 15/48

(52) U.S. Cl. 49/142; 49/506

(57) ABSTRACT

A sliding pivotable door as well as a method for operating a sliding pivotable door with at least one door leaf arrangement, which is accommodated to be pivotable about an associated pivot axis. The door leaf arrangement has a first door leaf, which is pivotable about the pivot axis, and at least one second door leaf is provided, which is linearly guided at the first door leaf and, together with the first door leaf, is pivotable about the pivot axis.

### BACKGROUND OF THE INVENTION

1. Field of the Invention

The present invention relates to a sliding pivotable door with at least one door leaf arrangement that is accommodated to be pivotable about an associated pivot axis. The present invention relates furthermore to a method for the opening and closing operation of the sliding pivotable door.

2. Description of the Related Art

A sliding pivotable door with a door leaf arrangement, accommodated to be pivotable about an associated pivot axis, is known from DE 196 00 444 A1. For guiding the sliding-pivoting movement of the door leaf arrangement, upper and/or lower guiding rails are required. The guiding rails, by which the door leaf arrangement is both guided and held, may be incorporated in the ceiling or in the floor of a room. This results in a folding movement, by which the door leaf arrangement achieves a pivoting range, which is smaller than the required pivoting range, determined by an exclusive pivoting movement of the door leaf arrangement about a pivot axis.

However, the required guiding rails in the upper and/or lower guiding areas are disadvantageous. Furthermore, driving the door leaf arrangement in a superimposed sliding-pivoting movement by the guiding rails is disadvantageous, if the sliding pivotable door is not to be exclusively manually operated. The door leaf arrangement may have several door leaves, which are in an arrangement at the left side and the right side with regard to each other. In such sliding pivotable doors, with the above described movement, the door leaves fold both to the left and to the right sides, such that the door leaves extend in a plane which is almost parallel with regard to the passage direction through the sliding pivotable door, if the latter is open. It is however desired to further increase the ratio between the passage width through the sliding pivotable door and the required pivoting range for opening the sliding pivotable door and/or to design it in a more variable way.

### SUMMARY OF THE INVENTION

It is an object of the present invention to provide a sliding pivotable door that overcomes the disadvantages of the aforementioned state-of-the-art and provides an improved sliding pivoting movement for the door leaf arrangement.

Accordingly one embodiment of the invention, the door leaf arrangement has a first door leaf, which is pivotable about a pivot axis, and at least one second door leaf is provided, which is linearly guided along the first door leaf and, together with the first door leaf, is pivotable about the pivot axis.

The invention is based at least in part on combining a first door leaf moved in a pivoting way with at least another second door leaf, which is moved linearly and in a pivoting way. In this case, the second door leaf is linearly movable disposed at the first door leaf. If the first door leaf executes a movement about the pivot axis, this pivoting movement continues in the second door leaf. However, the first door leaf is preferably exclusively moved in a pivoting way, whereas the second door leaf is able to execute a linear movement along the first door leaf, which movement is superimposed over the pivoting movement. In this case, the present invention is based at least in part on at least one second door leaf, but, within the scope of the present invention, an arbitrary number of further door leaves may be respectively disposed at each other and guided with regard to each other. Within the scope of the present invention, the sliding pivotable door may be embodied in particular as a double-leaf door, wherein a left door leaf arrangement and a right door leaf arrangement are provided, which respectively include two or more individual door leaves.

The linear movement of the second door leaf along the first door leaf may be configured in different ways. The first door leaf may be configured for example with double walls, wherein the two walls have a distance towards each other, thus forming a hollow space. The second door leaf may be guided during the entering movement into the hollow space between the walls of the first door leaf. The walls may consist of an arbitrary material, in particular glass, wood, or the like, or they may include one or more of these materials. Furthermore, the second door leaf may be guided along the first door leaf, while being parallel to it and spaced apart from it. In this case, the double wall execution of the first door leaf is preferably omitted, such that, in the opened condition of the door leaf arrangement, two or more door leaves are disposed next to each other in a stacked arrangement.

The door leaf arrangement is pivotable between a closed position and an opening position. In the closed position, the door leaves are essentially disposed linearly in front of each other and, in the opening position, they are disposed essentially next to each other. However, even in the closed position, a portion of the respective door leaves preferably still overlaps, because the door leaves need to retain each other. The sliding pivotable door may be provided with one or with two door leaf arrangements, wherein a sliding pivotable door with two door leaf arrangements, with regard to the passage direction, has one door leaf arrangement at the left side and one at the right side, and the pivot axes are respectively disposed at the outside.

The maximum opening width of the sliding pivotable door is thus determined by the distance between the two pivot axes with respect to each other. In a sliding pivotable door with a single, unilateral door leaf arrangement, the space, which the door leaf arrangement requires to move between the closed position and the opening position, can be almost cut in half, wherein the space, which two door leaf arrangements require with regard to the passage width through the sliding pivotable door, can be almost reduced to a quarter.

According to one embodiment of the invention, preferably for each door leaf arrangement, respectively a first electrical drive unit for driving the door leaf arrangement can be incorporated into the sliding pivotable door. As an alternative, the respective first electrical drive unit is adapted to be installed according to traditional mounting, i.e. transom and/or door leaf mounting on the pull side or on the push side with regard to the first door leaf of the respective door leaf arrangement.

As a further alternative, arrangements are possible in which the first electrical drive unit is inserted into the transom or into a similar stationary element, and an associated slide channel is inserted into the door panel, such as to be not visible from the outside. This arrangement may be reversed, such that the drive is inserted into the door panel of the first door leaf.

The first electrical drive unit performs the pivoting movement of the door leaves. However, according to one embodiment, in addition to driving the pivoting movement, the first electrical drive unit may drive the linear movement of the second door leaf along the first door leaf.

According to one embodiment of the sliding pivotable door, the latter may include, for each door leaf arrangement, respectively one pivoting column is intended to accommodate the respective door leaf arrangement. In this case, the first door leaf of the respective door leaf arrangement adjoins the pivoting column with its secondary closing edge, wherein the pivoting column can turn together with the pivoting movement of the connected door leaves, or the pivoting column is configured as a stationary pivoting column such that the door leaves execute a pivoting movement about the stationary pivoting column. The pivoting column may be configured in the shape of a tube such that at least the first electrical drive unit can be accommodated within the pivoting column. The first electrical drive unit may have a first electrical motor which is accommodated in the pivoting column and is configured for driving the pivoting movement of the door leaves and of the pivot axis.

According to one embodiment of the arrangement of the sliding pivotable door in a room, the pivoting column is rotatably accommodated via a top bearing and/or a floor pivot set, wherein the first electrical motor cooperates with a first gear unit, and wherein the pivoting movement of the door leaves can be generated by a mechanical operative connection between the first gear unit and the top bearing and/or the floor pivot set. For example, the unit, consisting of the first electrical motor and the gear unit, may be accommodated in the pivoting column in a torque-proof manner, wherein an output shaft is connected to the top bearing and/or the floor pivot set in a torque-proof manner.

The first electrical drive unit, which is in particular intended for executing the pivoting movement of the door leaf arrangement, may be provided more than once in the sliding pivotable door and in particular in the pivoting column. For example, a first electrical drive unit may be provided at the floor side and another identical electrical drive unit may be provided at the top side, such that the respective output shaft is connected to both, to the floor pivot set and to the top bearing.

With the intention to create another possible operative connection between the first electrical drive unit and a fixed bearing, in order to generate the pivoting movement of the door leaves, the pivoting column may have a section, which is preferably permanently attached to the building, in which the first electrical motor and/or the first gear unit are/is accommodated in a torque-proof manner. In this case, the output shaft of the first electrical drive unit acts at least upon a remaining, rotatable portion of the pivoting column. Operating the first electrical drive unit can set the pivoting column in rotational movement.

In addition to generating the rotational movement of the door leaf arrangement, the first electrical motor, via the first gear unit, may be furthermore provided for driving the telescopic movement of the second door leaf along the first door leaf.

A threaded spindle and/or a flexible drive may be used for driving the telescopic movement, wherein the first electrical motor drives the threaded spindle and/or the flexible drive via the first gear unit. Both, the threaded spindle and the flexible drive may be incorporated only in the head beam, only in the lower beam or in both beams of the first door leaf. Consequently, the first electrical drive unit may be provided within the pivoting column only at the top side or at the bottom side or at both, at the bottom side and at the top side.

According to another advantageous embodiment, the sliding pivotable door may include a second electrical drive unit. The latter may include at least one second electrical motor and at least one second gear unit connected to the motor. The second electrical motor, respectively the second gear unit, may be likewise accommodated within the pivoting column and may function to drive the telescopic movement of the second door leaf along the first door leaf.

In addition to incorporating the first electrical drive unit with the first electrical motor, respectively the first gear unit, as well as the second electrical drive unit with the second electrical motor, as well as the second gear unit, within the pivoting column, the drive units may be furthermore incorporated within the head beam and/or the lower beam. In particular the drive units may be incorporated in the floor or in the ceiling of the building in which the sliding pivotable door is accommodated.

With regard to all embodiments, the first electrical drive unit may be provided for carrying out the pivoting movement of the door leaf arrangement, and the telescopic movement of the at least one further door leaf can be carried out by the first electrical drive unit. If a second electrical drive unit is provided, this second unit can drive the telescopic movement of the one door leaf or more door leaves, whereas the first electrical drive unit can do both, drive the pivoting movement of the door leaf arrangement and function as a booster to the second electrical drive unit for the telescopic movement of the at least one door leaf.

According to an advantageous embodiment of the operative connection between the first and/or the second electrical motor, respectively between the first and/or the second gear unit and the threaded sprindle, a bevel gear toothing or a crown wheel toothing may be provided. If the telescopic movement of the at least one door leaf is driven via a flexible drive, the flexible drive wraps around at least one pulley, wherein the flexible drive may preferably consist of a toothed belt. In this case, the pulley, around which the toothed belt is wrapped, is in a driving connection with the first and/or with the second electrical motor, respectively with the first and/or the second gear unit. The threaded spindle and/or the flexible drive may be incorporated either only in the head beam, only in the lower beam or in both beams.

An electrical drive unit may in particular drive a threaded spindle, which is incorporated both in a head beam and in a lower beam, or an integral flexible drive, such that the door leaves are prevented from canting with respect to each other. Furthermore, the threaded spindles in the head beam and in the lower beam may be mechanically coupled to each other to carry out uniform rotational movement. Consequently, according to one embodiment, an electrical drive unit may act upon one threaded spindle, whereas the second threaded spindle is driven by being mechanically coupled to the first threaded spindle. This mechanical coupling may comprise for example a bevel gear toothing, provided twofold, or a belt drive, incorporated for example in the pivoting column.

In order to guide the door leaves towards each other, a guiding device may be provided at least between the first door leaf and the second door leaf. A guiding device may be incorporated in the head beam and/or the lower beam of the first door leaf, such that the guiding device guides the second door leaf along the head beam and/or the lower beam. The guiding device may be configured in the shape of a carriage and/or a guiding element, wherein the carriage may be affixed to the second door leaf and is guided in the head beam and/or in the lower beam of the first door leaf.

If the guiding device is configured as a guiding element, a ball-type linear guiding element may be utilized, which is guided in the head beam and/or in the lower beam. If the second door leaf is driven via a threaded spindle, the guide of the second door leaf may be connected to the drive unit. In this case, a threaded spindle may linearly drive a recirculating ball nut such that the second door leaf is both driven and guided via the recirculating ball nut, which moves linearly on the threaded spindle.

According to another driving concept of the second door leaf, a linear motor may be provided for carrying out the linear movement of the door leaf. This motor may be accommodated, preferably in the head beam and/or the lower beam of the first door leaf, to allow for driving the telescopic movement of the second door leaf along the first door leaf by the linear motor.

The linear motor may have a stator and a rotor. The stator may be incorporated within the head beam and/or the lower beam of the first door leaf. At least one rotor is present at the second door leaf in particular at the head beam and/or the lower beam, which rotor can be driven by a travelling magnetic field, which can be generated in the stator.

A travelling magnetic field can be generated in the stator such that the rotor executes a linear movement along the longitudinal extension of the head beam and/or the lower beam. As a consequence, the telescopic movement of the at least one further door leaf can be realized via a linear motor. The head beam and/or the lower beam may have a hollow space, into which the stator of the linear motor can be advantageously incorporated. In case several door leaves are telescopically disposed with each other, contact rails may be provided at the head beams and/or at the lower beams, to supply electrical energy to the one or more linear motors in the following leaf elements, or to activate them. Consequently, in the closed condition of the sliding pivotable door, the door leaves, suspended at each other, overlap at least in the area of the suspension. In this area, the coils, provided in the stator of one door leaf, must be brought to overlap, at least partially, the rotor of the opposite following door leaf, in order to achieve a drive effect.

According to an advantageous further embodiments of the inventive sliding pivotable door, a mechanical overload device may be provided at the first door leaf and/or the second door leaf, in order to allow for manually opening the door leaf arrangement. If the sliding pivotable door is utilized as an emergency exit door, the mechanical overload device offers the possibility to manually force the door leaf arrangement to open to the outside. The overload device may be formed by a spring-loaded rolling member, which is accommodated in a stationary transverse beam. In this case, the rolling member arrests the door leaf arrangement in the area of its frontal edge or in the area of the main closing edge of the first door leaf, if the door leaf arrangement has reached the closed position. In this case, the pre-tensioning of the spring, which presses the rolling member into an undercut, such as a depression, a groove or a step within the door leaf arrangement, yields at a defined manual actuating force. Subsequently, the rolling member pops out of the configured undercut, and the door leaf arrangement can be manually opened both in automatic opening direction and in a direction opposite to the motor-driven opening direction.

Advantageously, the first electrical motor and/or the second electrical motor may be embodied as a tubular motor, wherein the first electrical motor and/or the second electrical motor preferably present a second motor winding body, to create a redundant winding arrangement. In the embodiment case of the electrical motors as tubular motors, there is no occurrence of self-locking as it is the case in a worm gear, and the door leaf arrangement can be manually moved without the electrical drive unit blocking the rotational movement. Consequently, thanks to utilizing tubular motors, the sliding pivotable door is particularly well suited as an emergency exit door.

A redundant motor winding body results in higher operational safety of the sliding pivotable door when carrying out the opening movement. This so-called 2D-technology allows for electrical independent operation circuits, such that, in the event of an electrical failure of the first motor winding body, the existing redundant second motor winding body can still perform an opening movement of the door leaf arrangement and is preferably operated by a likewise redundant power circuit.

The present invention is furthermore directed to a method for an opening and closing operation of the sliding pivotable door. In this case, the pivoting movement of the door leaf arrangement can be executed independently from the linear movement of the second door leaf along the first door leaf. In this case, an embodiment of the sliding pivotable door is to be considered which has at least two electrical drive units, wherein the first electrical drive unit is provided exclusively for driving the pivoting movement and the second electrical drive unit is exclusively provided for driving the telescopic movement of the door leaves of the respective door leaf arrangement towards each other. This results in the advantage that the start of the pivoting movement and the start of the telescopic movement are not coupled to each other with regard to the timely sequence. As a consequence, the pivoting movement and the telescopic movement can be performed synchronously with regard to each other such that the two movements start at substantially the same time.

Furthermore, initially at least a portion of the linear movement of the second door leaf along the first door leaf may be carried out, in order to subsequently initiate the pivoting movement of the door leaf arrangement. The start of the pivoting movement can be intended once the linear movement has been completed, or the pivoting movement starts at an arbitrary time during the duration of movement of the second door leaf along the first door leaf.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Hereinafter, further measures enhancing the invention will be illustrated in detail in conjunction with the description of preferred embodiments of the invention, based on the Figures. In this case, all features and/or advantages including the constructional details, spatial dispositions and method steps, which result from the claims, the description or the drawings, may be essential to the invention, both by themselves and in their most various combinations.

FIG. 1 is a perspective view of an embodiment of a sliding pivotable door with a first door leaf and a second door leaf;

FIG. 2a is a diagrammatical view of a sliding pivotable door in a first variant of the method for carrying out the pivoting movement, as well as the linear movement;

FIG. 2b is a diagrammatical view of the sliding pivotable door in a second variant of the method for carrying out the pivoting movement, as well as the linear movement;

FIG. 2c is a diagrammatical view of the sliding pivotable door in a third variant of the method for carrying out the pivoting movement, as well as the linear movement;

FIG. 3a is a lateral view of the sliding pivotable door with a first drive unit for carrying out the pivoting movement and a second drive unit for carrying out the linear movement;

FIG. 3b is a lateral view of the sliding pivotable door with a first drive unit for carrying out both the pivoting movement and the linear movement;

FIG. 3c is a lateral view of the sliding pivotable door with a first electrical drive unit, which is in operative connection to a section permanently attached to the building, wherein the second electrical drive unit is provided on both the top side and the bottom side and effects the linear movement;

FIG. 4 is another embodiment of the sliding pivotable door with a drive unit provided in the head beam and a guiding device provided in the lower beam;

FIG. 5a is a lateral view of the sliding pivotable door, wherein the drive unit in the head beam has a carriage and wherein a guiding device is shown in the lower beam;

FIG. 5b is a lateral view of the sliding pivotable door with a first electrical drive unit, which effects both the rotational movement of the door leaf arrangement and the linear movement of the second door leaf by a flexible drive;

FIG. 5c is a lateral view of the sliding pivotable door, wherein a first electrical drive unit is operatively connected to the floor pivot set and wherein a second electrical drive unit effects the telescopic movement of the second door leaf via a flexible drive;

FIG. 6 is a lateral view of the sliding pivotable door with a first electrical drive unit, which is provided on both the top side and the bottom side of the sliding pivotable door and has a further redundant motor winding body;

FIG. 7a is a lateral view of the sliding pivotable door with a mechanical overload device, which is disposed in the area of the main closing edge of the first door leaf, respectively the secondary closing edge of the second door leaf;

FIG. 7b is a lateral view of the sliding pivotable door with a mechanical overload device, which is disposed in the area of the main closing edge of the second door leaf;

FIG. 7c is a top view on the sliding pivotable door wherein the movement of the door leaf arrangement is shown, which is possible by a manual opening;

FIG. 8a is a lateral view of the sliding pivotable door with a frame column for supporting the door leaf arrangement via the pivoting column; and

FIG. 8b is a lateral view of the sliding pivotable door with a transverse beam for receiving the pivoting column.

### DETAILED DESCRIPTION OF THE PRESENTLY PREFERRED EMBODIMENTS

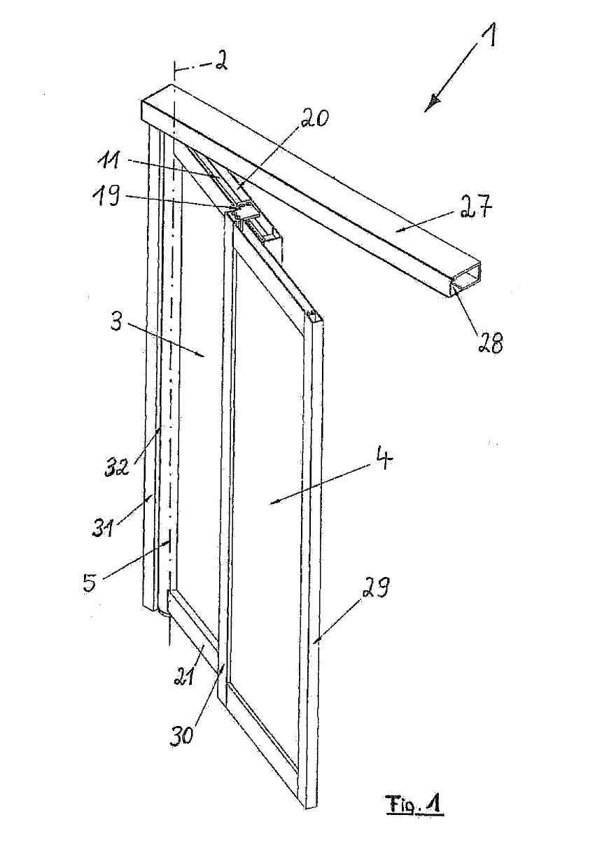

In a perspective view, FIG. 1 shows an embodiment of the inventive sliding pivotable door 1. The sliding pivotable door 1 may be accommodated in the wall or in the facade of a building such that the shown pivot axis 2 extends vertically. The frame of the sliding pivotable door 1 is formed by a vertical supporting member 31, which, may be formed by a wall of a building. A transverse beam 27 is shown at the top side, which, as a hollow body, is closable by a transverse beam enclosure 28 at the front side. The sliding pivotable door 1 has a pivoting column 5 which is parallel and adjacent to the vertical supporting member 31.

A first door leaf 3 is disposed to be pivotable about the pivot axis 2 such that the first door leaf 3 exclusively executes a pivoting movement about the pivot axis 2. The second door leaf 4 is accommodated and linearly guided at the first door leaf 3, such that the second door leaf 4 performs the pivoting movement together with the first door leaf 3 and is able to carry out a linear movement, respectively a telescopic movement, which is superimposed over the pivoting movement. The first and the second door leaves 3, 4 form a door leaf arrangement.

If the door leaf arrangement is opened, the first door leaf 3 pivots about the pivot axis 2, whereas the second door leaf 4, preferably simultaneously, performs a movement in the direction of the secondary closing edge 30 of the second door leaf 4. If, however, the door leaf arrangement is closed, the second door leaf 4 performs a linear movement in the direction of the main closing edge 29 of the second door leaf 4. The pivoting column 5 may rotate with the rotational movement of the door leaves 3 and 4, wherein, furthermore, the pivoting column 5 may be configured as a stationary pivoting column 5 such that the door leaves 3 and 4 pivot about the pivoting column 5 and the secondary closing edge 32 of the first door leaf 3 may be brought close to the external surface of the pivoting column 5.

To accommodate the second door leaf 4 at the first door leaf 3, respectively one threaded spindle 11 is provided at least in the area of the head beam 20 and preferably also in the area of the lower beam 21, which spindle can be motor-driven. The threaded spindle 11 acts upon guiding device 19, which, according to the illustration, is shown by a plate-shaped connection. Below the plate-shaped connection, a recirculating ball nut may be accommodated to be longitudinally movable above the threaded spindle 11, such that the linear movement of the second door leaf 4 along the first door leaf 3 is possible.

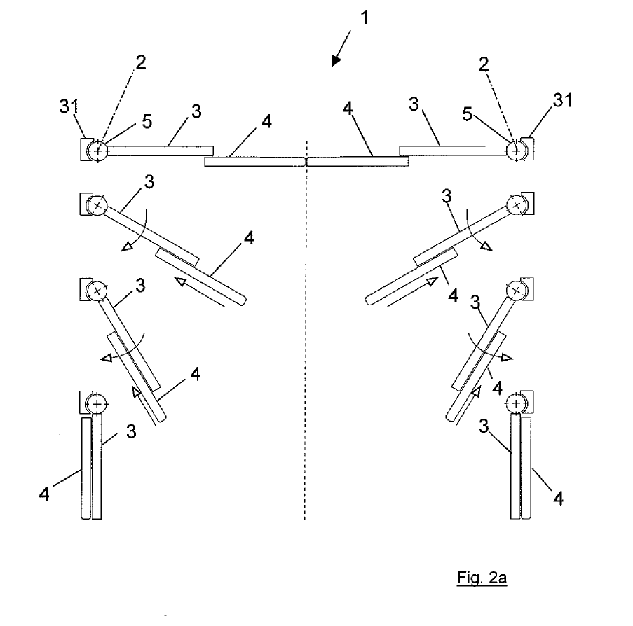

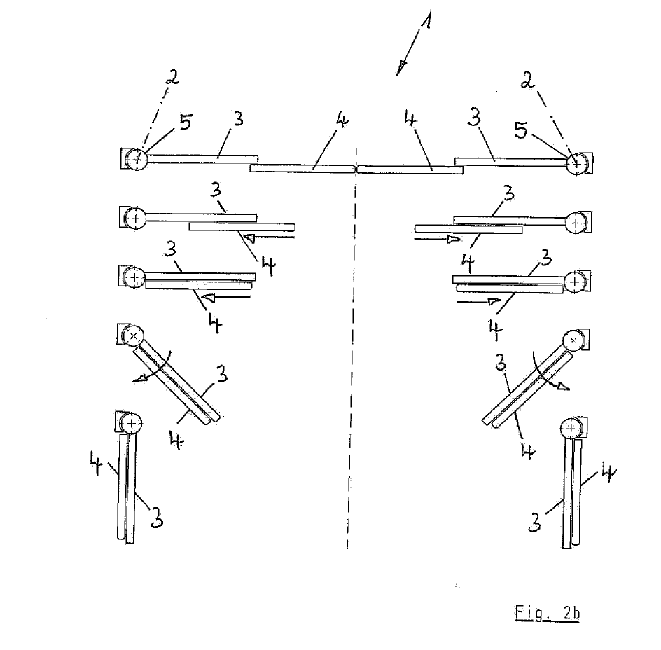

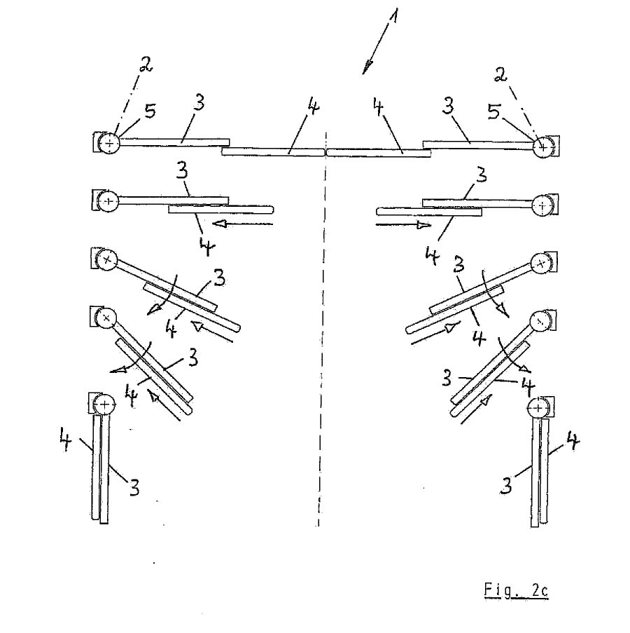

FIG. 2a depicts a method for the opening and closing operation of the sliding pivotable door 1. The sliding pivotable door 1 has two door leaf arrangements that are hinged to two outside located pivoting columns 5 with pivot axes 2, such that the door leaf arrangements are moved away from each other during the opening movement and they are moved towards each other during the closing movement. Three positions of the door leaf arrangement are shown during the opening movement, wherein the pivoting movement and the telescopic movement of the door leaves 3 and 4 about the pivot axis 2 are synchronously performed. Both the pivoting movement and the linear movement, in the following also named telescopic movement, are indicated by respective arrows. When observing the different opening positions of the door leaves 3 and 4, it becomes obvious that, despite a considerable passage width, given by the distance of the vertical supporting members 31 from each other, the required pivoting range of the door leaves 3 and 4 in the opened condition, corresponds to approximately the width of one door leaf 3 or 4.

FIG. 2b shows a variant of the method for the opening and closing operation of the door leaves 3 and 4 of the sliding pivotable door 1. In this case, the opening process of the door leaf arrangements starts with the linear movement of the second door leaf 4 along the first door leaf 3 in the direction of the respective pivoting column 5, respectively the pivot axis 2. Once the linear movement of the second door leaf 4 along the first door leaf 3 is completely executed, the pivoting movement for pivoting both door leaves 3 and 4 about the pivoting column 5 begins.

FIG. 2c shows another variant of the method for the opening and closing operation of the door leaves 3 and 4, wherein at first the linear movement of the second door leaf 4 along the first door leaf 3 starts in the respective direction of the respective pivoting column 5, respectively pivot axis 2. Once the linear movement is approximately half completed, the pivoting movement about the pivot axis 2 starts. As a result, independently from the pivoting and linear movements, only a pivoting range is utilized which is pre-determined by the width of the door leaves 3 and 4. Asynchronous linear and pivoting movements are typically only practical, if the linear movement begins shortly after the start of the pivoting movement, because otherwise a necessary pivoting range requires up to twice the width of the door leaves 3 and 4.

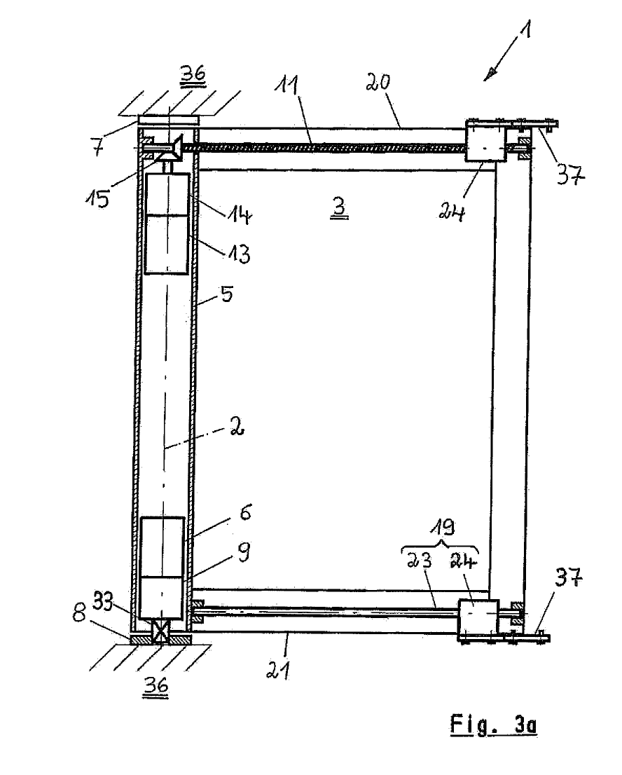

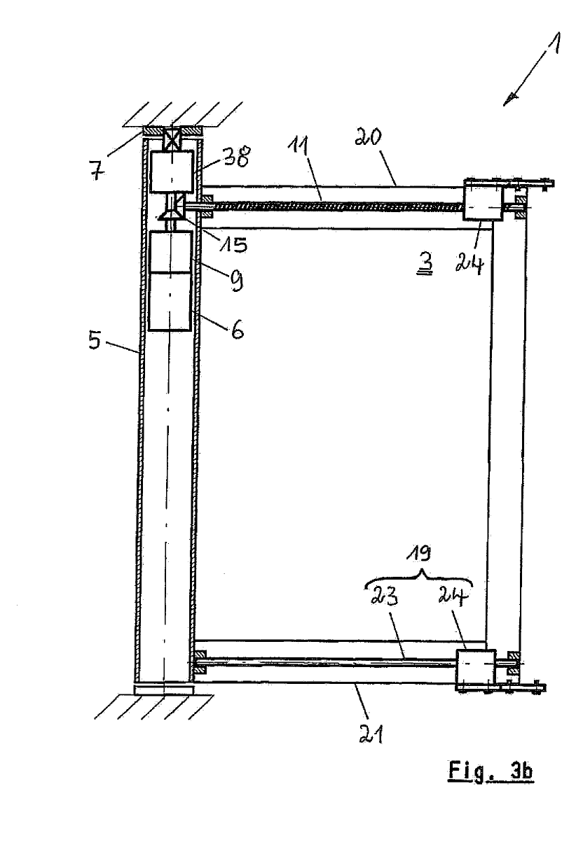

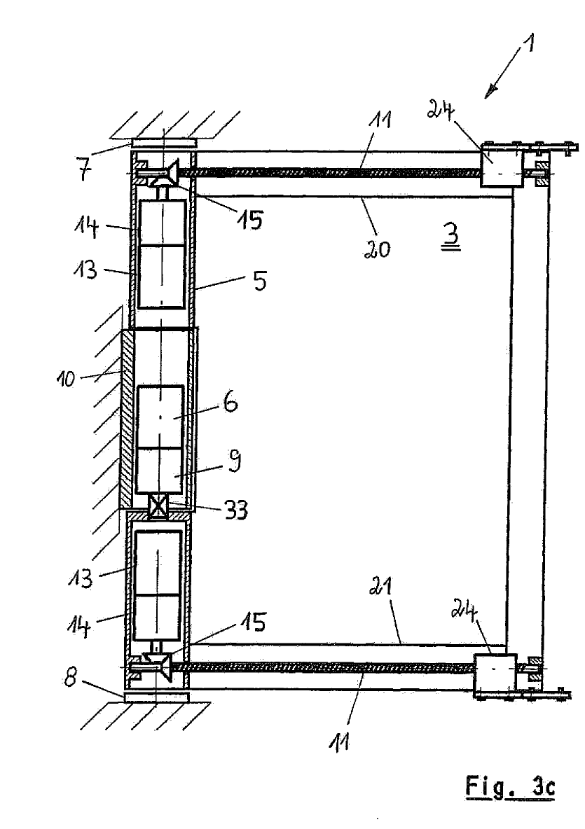

FIG. 3a is a lateral view of the sliding pivotable door 1, wherein the door is accommodated between an upper and a lower part of a shell of a building 36. The connection between the sliding pivotable door 1 and the shell of the building 36 is realized by a top bearing 7 and a floor pivot set 8. The door leaf arrangement is just shown in a simplified way by the first door leaf 3, which adjoins the pivoting column 5 extending between the top bearing 7 and the floor pivot set 8.

A first electrical drive unit, represented by a first electrical motor 6 and a first gear unit 9, is accommodated in the pivoting column 5 in a torque-proof manner. The first electrical drive unit serves to generate the pivoting movement of the door leaf arrangement, wherein an output shaft 33, which cooperates with the floor pivot set 8, extends from the first gear unit 9. If the first electrical motor 6 is operated, it can set the pivoting column 5 in a rotational movement and consequently the door leaf arrangement pivots about the pivot axis 2.

A second electrical drive unit, which is illustrated by a second electrical motor 13 and a second gear unit 14, is incorporated into the pivoting column 5. The second electrical drive unit acts upon a bevel gear toothing 15, which sets a threaded spindle 11 in rotational movement. The threaded spindle 11 is incorporated into the head beam 20 of the first door leaf 3, whereas a ball-type linear guiding element 24 is accommodated on the threaded spindle 11. The ball-type linear guiding element 24 serves for both, for guiding and for driving the second door leaf 4, wherein the distance of the ball-type linear guiding element 24 in relation to the pivot axis 2 can be changed by rotating the threaded spindle 11.

At a bottom side, the first door leaf 3 has a lower beam 21, in which a guiding element 23 is accommodated. Again a ball-type linear guiding element 24 is guided to be longitudinally movable on the guiding element 23, wherein, in operative connection with the guiding element 23, the ball-type linear guiding element 24 only assumes a guiding function and is not driven, such that the guiding element 23 and the ball-type linear guiding element 24 together form a guiding device 19. The ball-type linear guiding element 24, illustrated both at the top side and at the bottom side, is provided with connecting elements 37 to which the second door leaf 4 is linked.

FIG. 3b is another variant of the drive unit of the sliding pivotable door 1, wherein the door leaf arrangement is illustrated by the first door leaf 3. A threaded spindle 11, on which again a ball-type linear guiding element 24 is guided and driven, is accommodated in the head beam 20. The ball-type linear guiding element 24, which is accommodated on the guiding element 23 within the lower beam 21, again just fulfils a guiding function, such that the guiding element 23 and the ball-type linear guiding element 24 together form a guiding device 19.

According to this embodiment, the threaded spindle 11 is driven within the head beam 20 by the first electrical drive unit, which is formed by the first electrical motor 6 and the first gear unit 9. In this case, the gear unit 9 acts again upon the bevel gear toothing 15. Furthermore, the output of the first gear unit 9 is adjoined by a subsequent gear unit 38, which cooperates in such a way with the top bearing 7, that a pivoting movement in the pivoting column 5 and, as a consequence in the door leaf arrangement, can be generated. According to this embodiment, a single electrical drive unit is able to carry out both the pivoting movement and the telescopic movement, wherein the respective movements are kinematically coupled to each other.

FIG. 3c illustrates another embodiment for driving the pivoting movement as well as the telescopic movement of the door leaf arrangement. The first electrical drive unit is again represented by a first electrical motor 6, which is connected to a first gear unit 9. According to this embodiment, the pivoting column 5 is configured in several parts and has a section 10, which is permanently attached to the building. The section 10, permanently attached to the building, does not perform a rotational movement such that only the upper part of the pivoting column 5 as well as the lower part of the pivoting column 5 perform a rotational movement and enclose in between the third part, i.e. the immobile section 10, which is permanently attached to the building. Both the first electrical motor 6 and the first electrical gear unit 9 are received in a torque-proof manner within the section 10, which is permanently attached to the building, such that the output shaft 33 transfers a torque moment to the other parts of the pivoting column 5.

Transferring a torque moment to both the top bearing 7 and the floor pivot set 8 can thus be omitted. The second electrical drive unit is incorporated into the turning parts of the pivoting column 5 at both the top side and at the bottom side, which unit is represented by the second electrical motor 13 and the second gear unit 14, respectively at the top side and at the bottom side. The second electrical drives serve for driving the threaded spindles 11, wherein, according to this embodiment of the sliding pivotable door 1, one respective threaded spindle 11 is accommodated in the head beam 20 and in the lower beam 21 as well, and is operable via the second electrical drives by one respective bevel gear toothing 15. Ball-type linear guiding elements 24 are guided on the threaded spindles 11, which, as already described in the above embodiments, are linearly drivable by rotating the threaded spindles 11 and move the second, non-illustrated, door leaf 4 along the first door leaf 3.

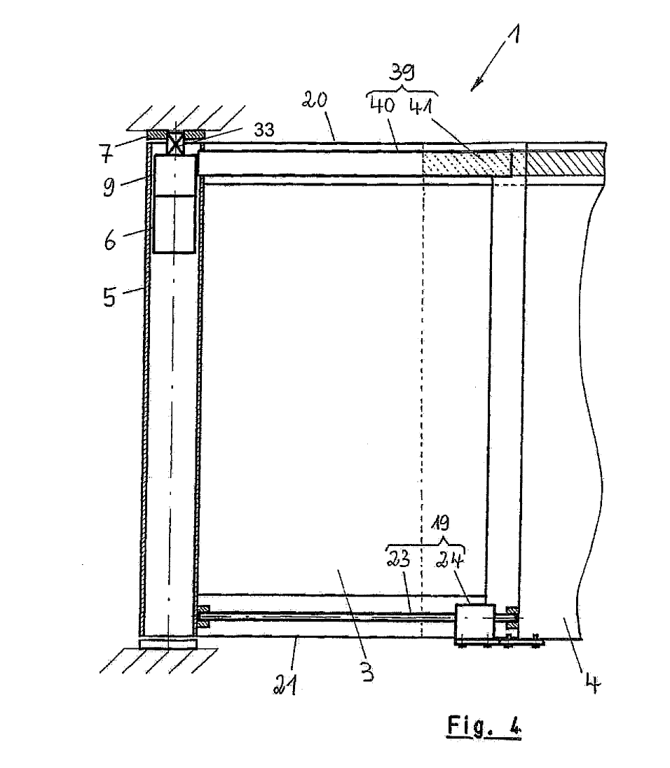

FIG. 4 is an embodiment of the sliding pivotable door 1, wherein the first electrical drive unit, represented by the first electrical motor 6 and the first gear unit 9, is accommodated in the pivoting column 5, and drives the pivoting of the door leaf arrangement by mechanically coupling the output shaft 33 to the top bearing 7. In addition to the traditionally executed first electrical drive, a linear motor 39 is provided which, by way of example, is illustrated to be incorporated in the head beam 20.

The linear motor 39 has a stator 40, in which a travelling magnetic field can be generated, such as to move a rotor 41 along the first door leaf 3. At the first door leaf 3, the stator 40 is accommodated in a lateral disposition within the head beam 20 and points into the direction of the second door leaf 4. The rotor 41, disposed at the second door leaf 4, is likewise accommodated in a lateral disposition such that the stator 40 and the rotor 4, adjacent to each other, are opposite each other.

If the stator 40 is correspondingly energized, the second door leaf 4 can be guided along the first door leaf 3. Again a guiding device 19, formed by the guiding element 23 and the ball-type linear guiding element 24, is accommodated in the lower beam 21 of the first door leaf 3. A guide, in the area of the head beam 20 is not illustrated in detail. The linear motor 39, with the stator 40 and the rotor 41, can be likewise accommodated in the same way in the lower beam 21 of the sliding pivotable door 1.

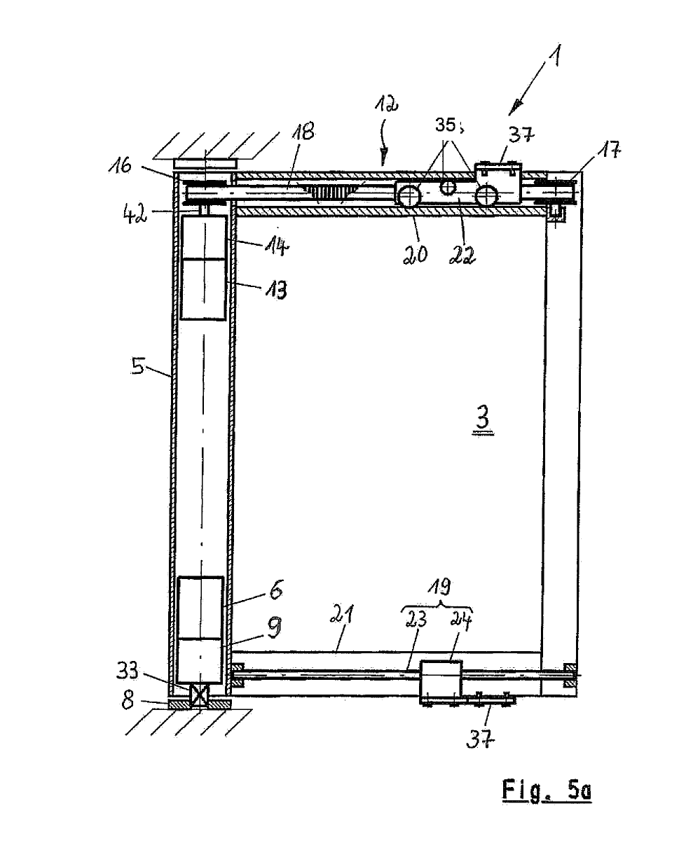

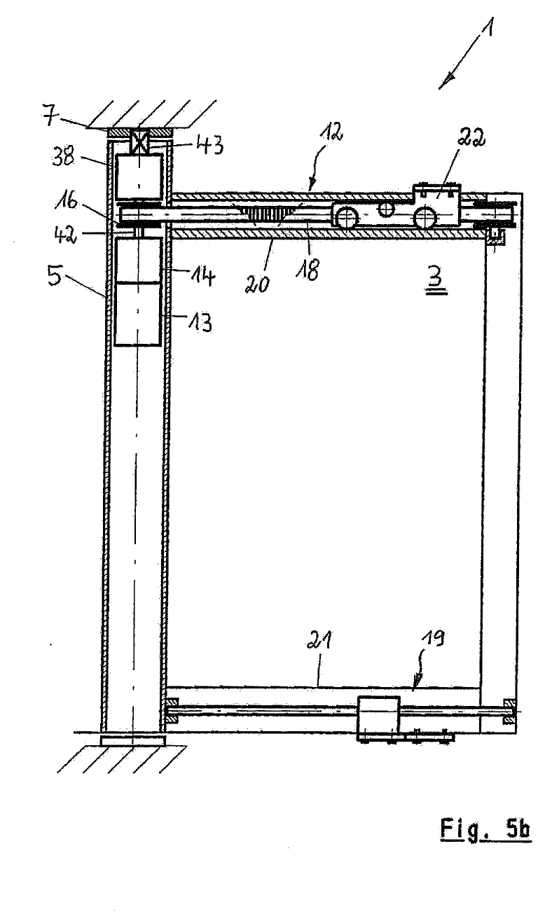

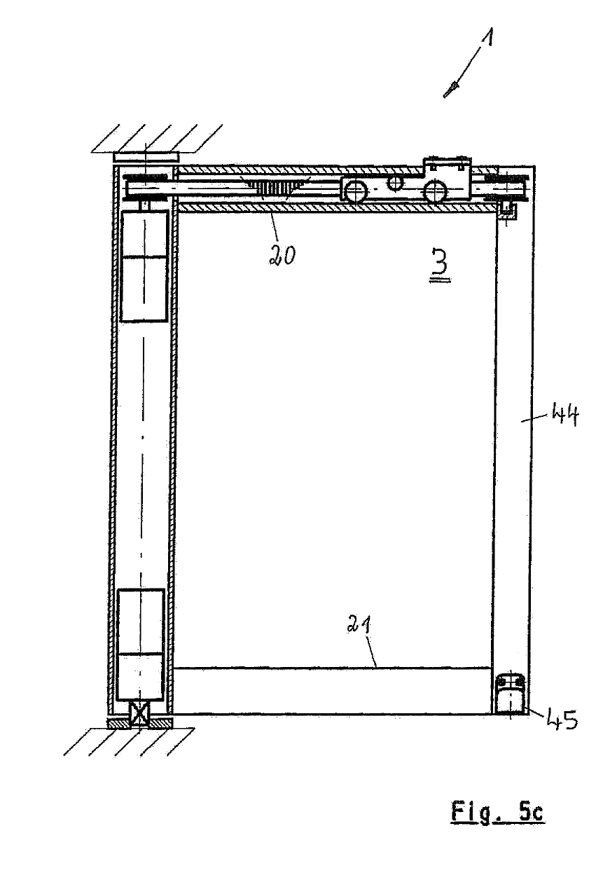

Another embodiment of a sliding pivotable door 1 is shown in FIG. 5a, in which a first electrical drive unit, formed by the first electrical motor 6 and the first gear unit 9, as well as a second electrical drive unit, formed by the second electrical motor 13 with the associated second gear unit 14, are accommodated in the pivoting column 5. The first electrical drive unit is accommodated at the bottom side in the pivoting column 5 and effects the pivoting movement of the door leaf arrangement by the operative connection between the output shaft 33 and the floor pivot set 8. A flexible drive 12 is accommodated in the head beam 20 of the door leaf 3. The drive comprises a first pulley 16 and a second pulley 17 around which a traction element, preferably configured as a toothed belt 18, is wrapped. The first pulley 16 is accommodated on the output shaft 42 of the second gear unit 14. By driving the pulley 16, the toothed belt 18 can be set in motion within the head beam 20.

A carriage 22, guided via rollers 35 within the head beam 20, is affixed to the toothed belt 18. The connecting element 37 is again disposed at the carriage 22 to accommodate the second, non-illustrated, door leaf 4. A guiding device 19, formed by the guiding element 23 and the ball-type linear guiding element 24, is accommodated in the lower beam 21. Another connecting element 37 is disposed at the ball-type linear guiding element 24 such that the second door leaf 4 is accommodated at the first door leaf 3 via the respective connecting elements 37.

FIG. 5b is a further embodiment according to FIG. 5a. In FIG. 5a, again the carriage 22 is accommodated in the head beam 20 and is driven by the flexible drive 12. The guiding device 19 is located in the lower beam 21 such that guiding and driving by the flexible drive 12 correspond to the illustration in FIG. 5a. The second electrical drive unit, which is formed by the second electrical motor 13 and the second gear unit 14, is provided for driving the pulley 16. Furthermore, a subsequent gear unit 38 is connected to the output shaft 42. The subsequent gear unit 38 may be configured as a planetary gear and have a connecting shaft 43, which is connected to the top bearing 7 in a torque-proof manner. If the output shaft 42 is rotated by the second electrical drive unit, at first the pulley 16 is set in rotational movement and the carriage 22 is moved along the head beam 20 of the toothed belt 18. Simultaneously a rotational movement is generated in the connecting shaft 43 via the subsequent gear unit 38, such that the pivoting column 5 performs a pivoting movement. Consequently, the second electrical drive unit is able to generate firstly the linear movement of the second door leaf along the first door leaf 3, and the second electrical drive unit can furthermore generate the pivoting movement of the door leaf arrangement as well.

FIG. 5c is a sliding pivotable door 1, wherein again only the first door leaf 3 is shown. The head beam 20 and the lower beam 21 are interconnected by a side profile 44 that forms the main closing edge of the first door leaf 3. A guide bracket 45 is mounted in the lower area of the side profile 44 in order to guide the second door leaf 4 at the bottom side of the first door leaf 3. Therefore the guiding device 19, as shown in the FIGS. 4 and 5a, can be omitted.

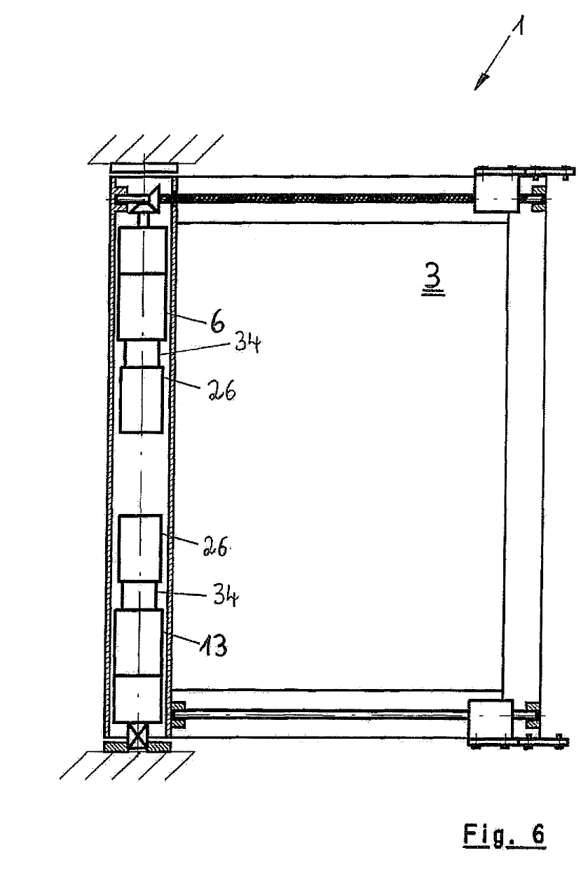

FIG. 6 is another embodiment of the sliding pivotable door 1, wherein the door leaf arrangement is again represented by the first door leaf 3. The first and second drive units correspond to the embodiment according to FIG. 3a. According to the present embodiment, both the first electrical motor 6 and the second electrical motor 13 have respectively another motor winding body 26, to provide a redundant winding arrangement. The motor winding bodies 26 are affixed to the electrical motors 6 and 13 at the end sides via mechanical coupling elements 34 and are likewise accommodated in the pivoting column 5. The redundant arrangement of further motor winding bodies 26 is applicable to any embodiment of the present sliding pivotable door 1.

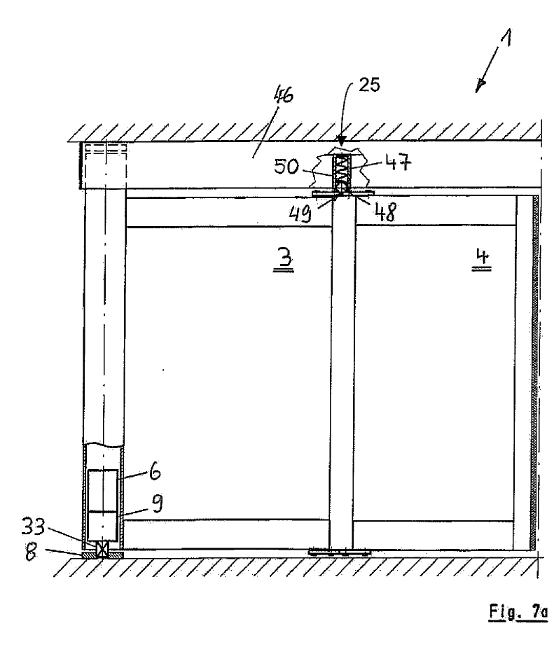

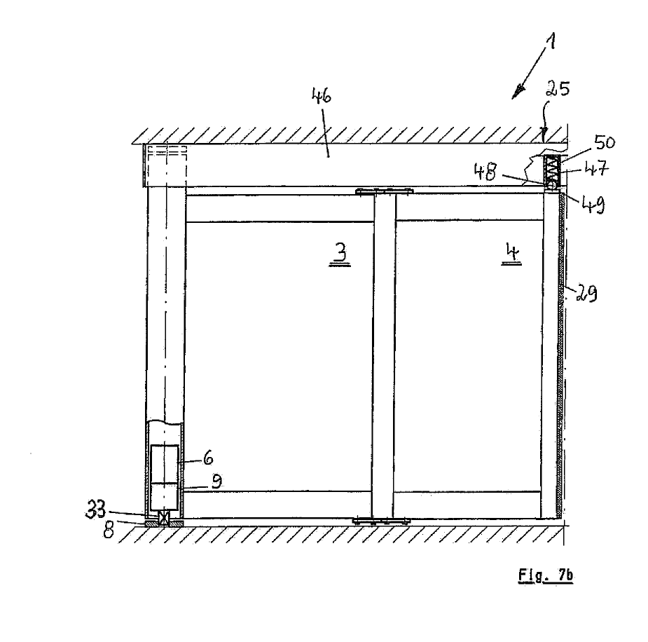

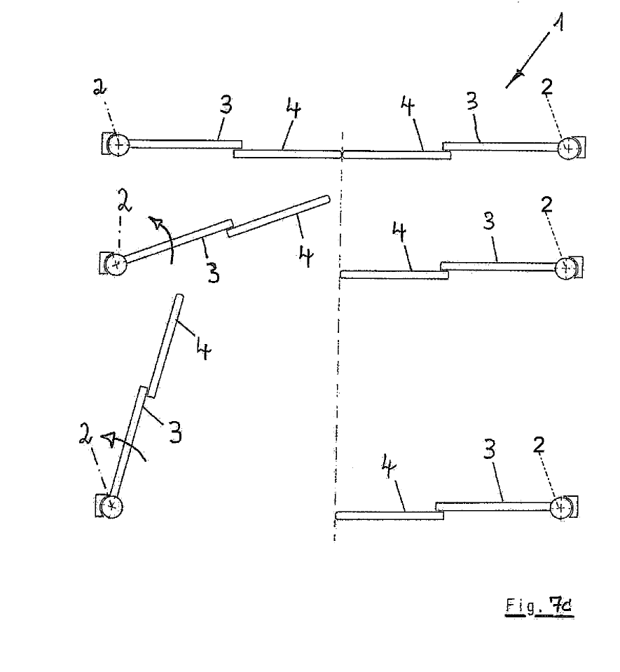

Another embodiment of a sliding pivotable door 1 is respectively shown in the FIGS. 7a and 7b, wherein the door leaf arrangement is illustrated by both the first door leaf 3 and the second door leaf 4. The sliding pivotable door 1 is shown in the closed position, wherein furthermore the first electrical drive unit is illustrated, which is represented by the first electrical motor 6 and the first gear unit 9 and cooperates with the floor pivot set 8 via the output shaft 33. The sliding pivotable door 1 is respectively configured with a mechanical overload device 25.

According to FIG. 7a, the mechanical overload device 25 is located between the door leaves 3 and 4, wherein, according to the illustration of FIG. 7b, the mechanical overload device 25 is disposed in the area of the main closing edge 29 of the second door leaf 4. The mechanical overload device 25 is accommodated in a stationary transverse beam 46 and has a spring element 47, which presses a rolling member 48 into an undercut 49. In order to open the door leaf arrangement, the rolling member 48 needs to be moved against the force of the spring element 47, such that the member pops out of the undercut 49. The spring element 47 is accommodated in a reception body 50 which can be recessed within the stationary transverse beam 46.

On account of the embodiment of the first electrical drive unit with a first gear unit 9 which may be configured as a planetary gear, and a first electrical motor 6, it is possible to likewise manually pivot the door leaf arrangement, because the electrical drive unit is not self-locking. An opening possibility is illustrated in FIG. 7c.

FIG. 7c shows the option of manually opening the sliding pivotable door 1 in a direction opposite to the provided automatic opening direction. The door leaves 3 and 4 are pivotable about the respective pivot axis 2, wherein only the left pair of door leaves 3, 4, respectively the left door leaf arrangement is opened by way of example. The door leaf arrangement only performs a pivoting movement and the second door leaf 4 does not perform a linear movement along the first door leaf 3. Such an opening possibility is only given in the event, where no mechanical coupling is provided between the pivoting movement of both door leaves 3 and 4 and the linear movement of the second door leaf 4 along the first door leaf 3. Such a mechanical coupling is given for example according to FIG. 3b and according to FIG. 5b.

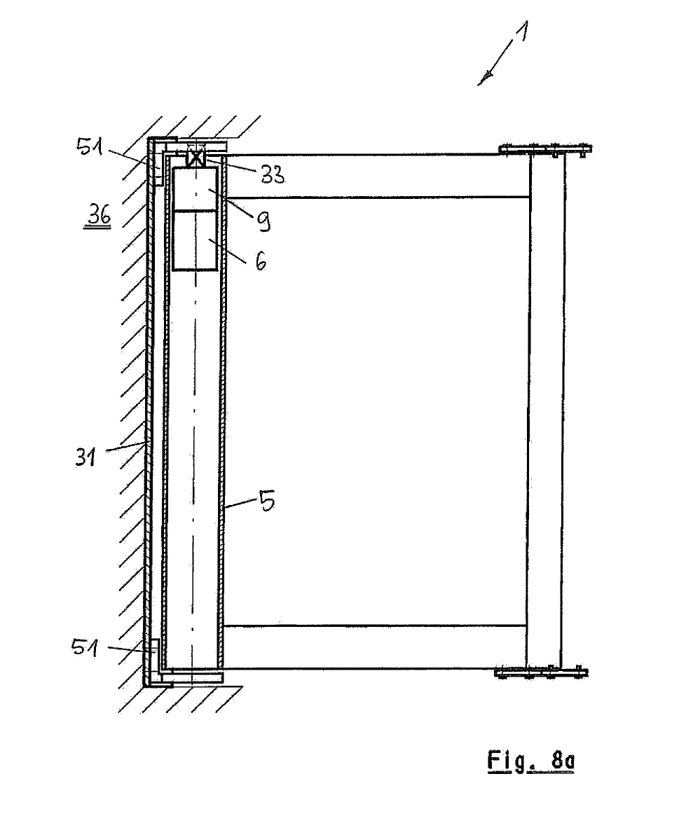

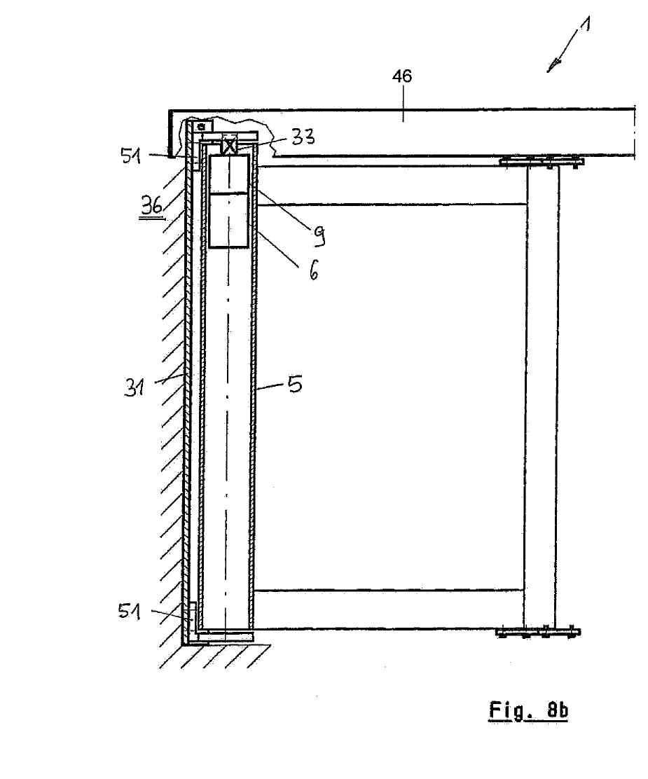

Respectively one other embodiment for accommodating the sliding pivotable door 1 within the shell of the building 36 is shown in FIGS. 8a and 8b. As an alternative to mounting the bearing of the pivoting column 5 directly at the floor and ceiling, shown in the aforementioned embodiments, a vertical supporting member 31 is shown to be firmly connected to the building. The advantages are found in an improved accommodation and adjustment of the upper and lower bearing elements for the pivoting column 5, wherein the sliding pivotable door 1 can be installed regardless of a finished floor being present or not. Furthermore, different variants of walls, passages or facades can be realized. The compensation for tolerances in the building can be likewise improved by combining different wall compensating elements.

According to the respective illustration, again a first electrical drive unit is provided, which is illustrated by the first electrical motor 6 and the first gear unit 9. In this case, the output shaft 33 cooperates with angle brackets 51, which furthermore serve to rotatably accommodate the pivoting column 5. In FIG. 8a, the vertical supporting member 31 is completely accommodated within the shell of the building 36, wherein, according to the illustration in FIG. 8b, a stationary transverse beam 46 is provided, which, at the top side, forms the reception for the angle bracket 51.

The invention in its configuration is not limited to the above presented preferred embodiment. On the contrary, a number of variants are conceivable, which make use of the presented solution, likewise with basically different types of executions. In particular the arrangement of the first electrical drive unit with the second electrical drive unit can be arbitrarily combined with each of the further illustrated features of the embodiments. Furthermore, the sliding pivotable door 1 is not limited to an embodiment with simply a first door leaf 3 and a second door leaf 4, because an arbitrary number of door leaves can be arranged consecutively.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A sliding pivotable door comprising:
at least one door leaf arrangement configured to be pivotable about a vertical associated pivot axis, having:
a first door leaf, arranged proximate to the associated pivot axis and configured to be pivotable about the associated pivot axis; and
at least one second door leaf pivotable about the pivot axis that is linearly guided and disposed with respect to the first door leaf.

2. The sliding pivotable door according to claim 1, wherein the first door leaf comprises two walls with a space therebetween and the second door leaf is configured to one of:
telescopically move and enter the space between the two walls of the first door leaf, and
be guided to move parallel and spaced apart from the first door leaf, towards and away from the associated pivot axis.

3. The sliding pivotable door according to claim 1, wherein the at least one door leaf arrangement is pivotable between a closed position and an opening position, wherein, in the closed position, the door leaves are essentially disposed substantially linearly in front of each other extending from the associated pivot axis and, in the opening position, they are disposed essentially next to each other.

4. The sliding pivotable door according to claim 1, wherein, the sliding pivotable door is configured with a door leaf arrangement at the left side and at the right side, meeting at a middle, and wherein the pivot axes are disposed at outer edges opposite the middle.

5. The sliding pivotable door according to claim 1, further comprising a first electrical drive unit configured to drive at least the pivoting movement of the door leaves about the associated pivot axis.

6. The sliding pivotable door according to claim 5, further comprising a pivoting column, wherein the first electrical drive unit is arranged in the pivoting column.

7. The sliding pivotable door according to claim 6, wherein the door leaf arrangement is accommodated at the pivoting column, the first door leaf is adjacent to the pivoting column and the pivoting column turns with the pivoting movement of the door leaves.

8. The sliding pivotable door according to claim 6, wherein the pivoting column is configured as a stationary pivoting column such that the door leaves perform a pivoting movement about the pivoting column.

9. The sliding pivotable door according to claim 6, wherein the first electrical drive unit has a first electrical motor arranged within the pivoting column and configured for driving the pivoting movement of the door leaves about the pivoting column.

10. The sliding pivotable door according to claim 9, further comprising at least one of a top bearing and a floor pivot configured to rotatably accommodated the pivoting column, wherein the first electrical motor cooperates with a first gear unit to generate, by a mechanical operative connection between the first gear unit and one of the top bearing and the floor pivot set, the pivoting movement of the door leaves.

11. The sliding pivotable door according to claim 9, wherein the pivoting column has at least one section permanently attached to a building, with which section the first electrical drive unit generates the pivoting movement of the door leaves.

12. The sliding pivotable door according to claim 9, wherein the first electrical motor is configured to drive the telescopic movement of the second door leaf along the first door leaf.

13. The sliding pivotable door according to claim 12, wherein one of a threaded spindle and a flexible drive is arranged for driving the telescopic movement, wherein the first electrical motor drives the at least one of the threaded spindle and the flexible drive via the first gear unit.

14. The sliding pivotable door according to claim 6, further comprising a second electrical drive unit comprising a second electrical motor and a second gear unit operatively connected to the first motor configured to drive the telescopic movement of the second door leaf along the first door leaf.

15. The sliding pivotable door according to claim 14, wherein the second electrical motor and the second gear unit are accommodated in the pivoting column.

16. The sliding pivotable door according to claim 13, wherein the operative connection between at least one of the first and the second electrical motor, respectively between the first and the second gear unit and the threaded spindle has one of a bevel gear toothing, a crown wheel toothing, and the flexible drive has at least one pulley, around which a traction element is guided, wherein the pulley is in driving connection with one of the first and the second electrical motor, and respectively with the one of the first and the second gear unit.

17. The sliding pivotable door according to claim 1, further comprising at least one guiding element provided between the first door leaf and the second door leaf, wherein at least the first door leaf has one of a head beam and a lower beam in which the second door leaf is guided via the guiding element.

18. The sliding pivotable door according to claim 16, wherein the guiding device has at least one carriage and a ball-type linear guiding element guided on a guiding element, which carriage or element is guided in one of the head beam and in the lower beam.

19. The sliding pivotable door according to claim 16, wherein at least one linear motor is provided which is disposed such that the at least one linear motor allows for driving the telescopic movement of the second door leaf along the first door leaf.

20. The sliding pivotable door according to claim 19, wherein the at least one linear motor is accommodated in at least one of the head beam and the lower beam.

21. The sliding pivotable door according to claim 1, further comprising a mechanical overload device arranged in at least one of the first door leaf and the second door leaf to allow for manually opening the door leaf arrangement.

22. The sliding pivotable door according to claim 9, wherein at least one of the first electrical motor and the second electrical motor is configured as a tubular motor.

23. The sliding pivotable door according to claim 22, wherein at least one of the first electrical motor and the second electrical motor respectively has a second motor winding body to create a redundant winding arrangement.

24. A method for the opening and closing operation of a sliding pivotable door comprising:
at least one door leaf arrangement configured to be pivotable about a vertical associated pivot axis, having:
a first door leaf, arranged proximate to the associated pivot axis and configured to be pivotable about the associated pivot axis; and
at least one second door leaf pivotable about the pivot axis that is linearly guided and disposed with respect to the first door leaf, the method comprising:
linearly moving the at least one second door leaf of the at least one door leaf arrangement at the first door leaf of the at least one door leaf arrangement; and
pivoting the first door leaf of the at least one door leaf arrangement about the associated pivot axis one of independently and dependently from the linear movement of the second door leaf along the first door leaf.

25. The method according to claim 24, wherein at least one of:
a portion of the linear movement of the second door leaf along the first door leaf is performed initially and subsequently the pivoting movement of the door leaf arrangement is initiated, and
the pivoting movement and the linear movement are synchronously performed over the entire pivoting path.
